(19) United States
(12) Patent Application Publication
(10) Pub. No.: US 2018/0171216 A1
(43) Pub. Date: Jun. 21, 2018

(54) AQUEOUS RESIN SOLUTIONS FOR PASSIVE OPACIFICATION

(71) Applicant: BASF Coatings GmbH, Münster (DE)

(72) Inventors: Charles L. Tazzia, Grosse Pointe, MI (US); Brad J. Martin, Dearborn, MI (US); Mark Paul Kujawski, Grosse Pointe Woods, MI (US); Mark Donald Swartzlander, Royal Oak, MI (US)

(21) Appl. No.: 15/578,529

(22) PCT Filed: Jun. 1, 2016
(86) PCT No.: PCT/EP2016/062344

§ 371 Date: Nov. 30, 2017

Related U.S. Application Data
(60) Provisional application No. 62/183,442, filed on Jun. 23, 2015.

(51) Int. Cl. C09K 9/02; C08G 59/06; C08K 3/16; C08G 59/32; C08G 59/50; B32B 7/12; B32B 9/00; B32B 17/10; B32B 27/08; B32B 27/38

(52) U.S. Cl. CPC C09K 9/02; B32B 2551/00; C08K 3/16; C08G 59/32; C08G 59/504; B32B 7/12; B32B 9/005; B32B 17/10036; B32B 17/10733; B32B 27/08; B32B 27/38; C08K 2003/162; C09K 2211/1433; B32B 2307/412; C08G 59/06

(57) ABSTRACT

Provided herein are aqueous resin solutions providing passive opacification and products incorporating the same. The opacity of the water-based materials provided herein change over a desired temperature range increase (0° C. to <100° C.) at ambient pressure. A specific epoxy functional resin/polymer suitable for the resin solutions are prepared by reacting (A) an epoxy pre-polymer of (1) one or more polyols and (2) one or more epoxy functional materials with (B) a di- or polyamine, and upon formation, dissolution in water, and neutralization, an ionic strength adjuster is added, thereby forming the passive opacification resin solution. The resin solutions are substantially free of cross-linking agents.

### TECHNICAL FIELD

The present invention is directed to aqueous resin solutions whose opacity changes within a particular temperature range increase. Some of the resin solutions also have viscosities that increase significantly. The opacity and viscosity properties are reversible. Such properties may be tuned for desired opacity and optionally viscosity changes over desired temperatures. These solutions may be used for non-coatings applications such as solar cells, building windows and sky lights, vehicle windows and roofs, greenhouses, optical lenses, and other products that are transparent at some times during use and can benefit from being opaque during other times of use.

### BACKGROUND

The ability of a product to change its opacity has many practical applications. In U.S. Pat. No. 4,268,413, bodies in the form of films or foils with reversibly variable temperature-dependent light absorbance are used for determining temperature, which, in turn, may be used in devices to warn about slippery ice conditions or about excess temperatures. In U.S. Pat. No. 3,244,582, light transmitting materials, in particular foils and sheets, of synthetic material such as polyvinyl alcohol complexes whose light permeability varies in dependence on the ambient atmosphere and/or the light intensity are provided. The foils of the '582 patent may be used, for example, in conjunction with a rigid plastic layer as a replacement for multi-layered silicate glasses or in conjunction with flexible synthetic layers for use in agriculture and horticulture.

U.S. Pat. No. 4,743,557 discloses a temperature indicating device that utilizes a composition whose opacity will indicate when either over- or under-exposure to a related temperature range has occurred, for example in a refrigerator. The compositions of the '557 patent rely on a chemical or combination of chemicals falling out of solution to cause an opacity change. Aliphatic or aromatic hydrocarbons, alcohols, ketones, esters, acids and ethers are identified.

There is a need to provide products providing opacity changes that are environmentally friendly and are easily handled.

### SUMMARY

Provided are resin-based products that are environmentally friendly and are easily handled. In addition, the resin-based products provided herein, specifically resin solutions and products incorporating the same, provide beneficial rheological properties. In co-owned U.S. Ser. No. 62/050,290, incorporated herein by reference, it was found that omission of cross-linking agents during formation of traditional resin coating dispersions, such as those containing both a hydrophobic group and a hydrophilic group, for example epoxy resins and/or polyurethane resins, resulted in resin solutions having desirable properties in many non-coating applications, which are applications other than those used to make polymeric coatings on substrates. It has been found herein that the addition of an ionic strength adjuster, for example, an inorganic or organic salt, to cross-linker-free resin coating solutions as disclosed in co-owned U.S. Ser. No. 62/050,290 results in a material having desirable properties in many non-coating applications, especially applications where a change in opacity is desirable.

Suitable resins containing both a hydrophobic group and a hydrophilic group for use in the resin solutions of the present invention include but are not limited to epoxy resins, phenol-formaldehyde resins, polyurethane resins, acrylic resins, polyester resins, acrylic-urethane resins, melamine resins, melamine-formaldehyde resins, amino resins, and combinations thereof. Basic resin chemistries are known in the art. For example, epoxy functional resins/polymers suitable for use in the resin solutions of the present invention can be prepared by reacting (A) an epoxy pre-polymer of (1) one or more polyols and (2) one or more epoxy functional materials with (B) a di- or polyamine. Upon dissolution of the resin in water and neutralization, an aqueous thermo-thickening resin solution where the viscosities of the solutions increase significantly within a relatively small temperature range increase is generally formed. Upon the addition of an ionic strength adjuster, the opacity of such solutions changes over a temperature range. The opacity and viscosity properties are reversible. Such properties may be tuned for desired changes over desired temperatures, modest or extreme. These solutions may be used for non-coatings applications such as solar cells; building windows and sky lights; vehicle windows and roofs; greenhouses; electronic devices with screens such as televisions, smart phones, tablets, and the like; and other products that are transparent at some times during use and can benefit from being opaque during other times of use. Such solutions may also be used in conjunction transportation vehicles or the human body or other products or things to disrupt or shield light emissions outside of the visible spectral range (e.g. infrared IR).

The rheology of the resin solutions is impacted by factors such as starting polymers, non-volatiles (NV) content, total neutralization (TN), organic solvent content, and ionic strength. Optionally additives to reduce the freezing point of the aqueous resin solution may be added. There are unlimited combinations of these factors, which may be tailored to specific applications.

In the temperature range of 0° C. to <100° C. at ambient pressure, the dynamic viscosity of the aqueous thermo-thickening resin solution may display at least one maximum, which may be referred to as a thermo-thickening temperature. Some resin solutions may exhibit two or more maximum viscosities in a desired temperature range.

In a first aspect, an aqueous resin solution for non-coating applications comprises: a resin comprising a hydrophobic group and a hydrophilic group, the resin being selected from an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof; and water; optionally, a salting component; an ionic strength adjuster; the solution being substantially free of a cross-linking agent; wherein the solution exhibits a change in opacity in a temperature range from 0° C. to <100° C. at ambient pressure. When the salting component is present, it may be selected from the group consisting of organic acids, mineral acids, and nitrogen-containing compounds. The ionic strength adjuster may comprise one or more compounds selected from the group consisting of: inorganic salts, ammonium salts, and metal organic salts. The ionic strength adjuster may comprise one or more compounds selected from the group consisting of: calcium chloride, sodium chloride, ammonium sulfate, calcium stearate, and sodium acetate.

The resin may be a reaction product of (A) an epoxy pre-polymer comprising an aromatic polyol and an epoxy functional material and (B) a di- or polyamine. The aromatic polyol may comprise a diphenylmethane derivative. The epoxy functional material may comprise a di- or polyglycidyl ether of a polyhydric alcohol. The di- or polyamine may comprise a polyoxyalkylene amine. In a detailed embodiment, the aromatic polyol may comprise bisphenol A (Bis A), the epoxy functional material may comprise diglycidyl ether of bisphenol A (DGEBA), and the di- or polyamine may comprise polyether amine.

A detailed aspect is an aqueous resin solution comprising by weight: an epoxy resin in the range of 0.5-60%; water in the range of 40-99.5%; organic volatiles in the range of 0-25%; and an ionic strength adjuster in the range of 0.1 to 10%. The ionic strength adjuster may comprise one or more inorganic salts, ammonium salts, or metal organic salts selected from the group consisting of: calcium chloride, sodium chloride, ammonium sulfate, calcium stearate, and sodium acetate. Percent neutralization of the solution may be in the range of 40-110%. A number average molecular weight may be in the range of 7,500 to 150,000 Daltons. The epoxy resin may be a reaction product of (A) an epoxy pre-polymer comprising an aromatic polyol and an epoxy functional material and (B) a di- or polyamine and the ionic strength adjuster may comprise calcium chloride.

Another aspect is a product with passive opacification comprising: an underlying product; and any aqueous resin solution disclosed herein associated with the underlying product. The underlying product may be a transparent product comprising a transparent portion that is one or more of the following: glass, plexi-glass, a clear discrete polymer film, a transparent mineral, and a fluid. The products herein may be in the form of one or more of the following: solar cells, building windows, sky lights, vehicle windows, vehicle roofs, greenhouses, optical lenses, electronic devices with screens, and transportation vehicles.

A further aspect is a method of making an aqueous resin solution for non-coating applications, the method comprising: forming a resin comprising a hydrophobic group and a hydrophilic group, the resin being selected from an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof; and dissolving the resin in water, and optionally, a salting component, in the substantial absence of a cross-linking agent; adding an ionic strength adjuster; thereby forming the aqueous resin solution that exhibits a change in opacity over a temperature range from 0° C. to <100° C. at ambient pressure. The resin may be is a reaction product of (A) an epoxy pre-polymer comprising an aromatic polyol and an epoxy functional material and (B) a di- or polyamine. The aromatic polyol may comprise bisphenol A (Bis A), the epoxy functional material comprises diglycidyl ether of bisphenol A (DGEBA), and the di- or polyamine comprises polyether amine.

Another aspect is a method of providing a product with passive opacification, the method comprising: obtaining any aqueous resin solution disclosed herein; associating the aqueous resin solution with an underlying product; and forming the product with passive opacification whose opacity changes over a temperature range from 0° C. to <100° C. at ambient pressure.

Also provided are uses of an aqueous resin solution in non-coating applications to provide a change in opacity over a temperature range of about 0° C. to <100° C. at ambient pressure.

### BRIEF DESCRIPTION OF THE DRAWINGS

The disclosure may be more completely understood in consideration of the following detailed description of various embodiments of the disclosure in connection with the accompanying drawings, in which:

FIG. 1 is a log-plot of viscosity versus temperature of an exemplary resin solution having no volatile organic compounds, a non-volatiles content of 30%, a total neutralization of 70%, and an alkaline earth salt content of 1 wt. % as compared to a solution without the salt;

FIG. 2 is a photograph showing transparency of a resin solution at 21° C.;

FIG. 3 is a photograph showing opacity of the same resin solution of FIG. 2 at >50° C.;

FIG. 4 shows percent transmission versus temperature for Samples C, F, I, and L for sample thicknesses of 1/16″;

FIG. 5 shows percent transmission versus temperature for Samples P, Q, I, and R for various sample thicknesses;

FIG. 6 shows temperature versus time for a test cell having a window pane with a ⅛″ thick void space that was filled with air, water, or a polymer resin and a halogen light 7″ away;

FIG. 7 shows temperature versus time for a test cell having a window pane with a ⅛″ thick void space that was filled with air, water, or a polymer resin and a halogen light 14″ away; and

FIG. 8 shows temperature versus time for a test cell having a window pane with varying void space thicknesses that were filled with water or a polymer resin and a halogen light 14″ away.

### DETAILED DESCRIPTION

Provided are aqueous resin solutions having unique rheologies and products incorporating the same. At elevated temperatures, these materials transition from transparent to opaque. Also, prior to experiencing a change in opacity, some of these materials exhibit a thermo-thickening effect, which is an increase in viscosity as temperature rises. This is opposite to traditional materials, which exhibit a drop in viscosity as temperature increases. The response to temperature including passive opacification, and optionally thermo-thickening, can be tuned across a wide temperature range through a variety of formulation parameters such as resin concentration, molecular weight (number average: Mₙ), solution pH, solution ionic strength, and hydrophilic lipophilic balance of the resin. Optionally additives to reduce the freezing point of the aqueous resin solution may be added. This process is completely reversible; the materials return to their original viscosity and transparency when returned to their original temperature. This process can be cycled repeatedly without any loss of function. These resins are water based, and exhibit a viscosity and opacity transition that can be tuned to respond between 0° C. and <100° C. This broad temperature range allows for several potential applications outside of coatings.

The following terms shall have, for the purposes of this application, the respective meanings set forth below.

Reference to “passive opacification” means that change in opacity based on condition changes, specifically temperature and/or pressure, to its environment in the absence of direct external stimulus such as, but not limited to, an electrical power source.

A “solution” means a clear single phase liquid having two or more ingredients where one is substantially dissolved in the other. For example, an aqueous resin solution means that the resin is substantially dissolved in water such that upon visual inspection, only one phase is present.

“Ionic strength adjuster” means a chemical compound that is water-soluble, that is, it dissociates in water, thereby adding ions to an aqueous solution. Such compounds modify the solubility of the resin in water and are not expected to form a salt with the resin. Exemplary ionic strength adjusters include but are not limited to inorganic salts, for example, alkaline earth salts such as calcium chloride, alkali salts such as sodium chloride, ammonium salts such as ammonium sulfate, and metal organic salts such as calcium stearate or sodium acetate.

A “dispersion” means a cloudy material having at least two phases where one ingredient is suspended or dispersed in the other. For example, an aqueous resin dispersion means that the resin is suspended in water such that upon visual inspection, the dispersion is not clear.

An “aromatic group” refers to a compound having a conjugated ring of unsaturated bonds, lone pairs, or empty orbitals. In specific instances, an aromatic group means a ringed-hydrocarbon having alternating double and single bonds between carbon atoms.

A “hydrophilic group” means a group with adequate or ample oxygen and/or nitrogen and/or electronegative moiety content that renders it able to interact with polar liquids through, for example, hydrogen bonding.

A “hydrophobic group” means a group that is aliphatic or aromatic and generally free of electronegative moieties (oxygen, nitrogen, and the like) that does not interact with polar liquids.

A “salting component” means a compound that dissociates in water and forms a salt with the resin. Exemplary salting components are organic acids such as acetic acid, mineral acids such as sulfuric acid, bases such as sodium hydroxide, and other organic bases/compounds such as amines.

“Substantially free of a cross-linking agent” means that no material suitable for cross-linking the resin is intentionally added to the solution. Thus, the presence of traces of such an agent due to minor cross-contamination or accidental inclusion does not preclude the solution from being substantially free of the agent.

“Substantially free of an organic solvent” or “organic volatile” means that most organic solvent used during polymerization is removed, by, for example, vacuum stripping. Residual organic solvent may be present in amounts of up to 5 weight-%, or even 3 weight-%. Also, no organic solvent material is intentionally added to the solution. Thus, the presence of traces of such a solvent due to minor cross-contamination or accidental inclusion does not preclude the solution from being substantially free of the solvent. Volatile organic content (VOC) refers to the content of organic volatiles, this number excludes water content.

“Non-volatiles (NV) content” refers to the content of material that does not evaporate at ambient or room temperature (e.g. 20-25° C. (68-77° C.)). Non-volatiles content is typically measured by ASTM method: D-2369, one hour at 110° C. For a resin solution comprising resin and water and organic volatiles, the non-volatiles (NV) content refers to the resin content, which excludes the water and organic volatiles content.

“Total neutralization” (TN) is the number of equivalents of salting sites that are neutralized. For resins having an amine co-reactant, for example, TN refers to the number of equivalents of nitrogen (N) neutralized. Percent neutralization is the percent of such salting sites that are neutralized.

“Dynamic viscosity” refers to the resistance of a fluid to shear stress. Dynamic viscosity may be measured by a Rheometric Scientific Shear Stress Controlled Rheometer (SR-2000), having a Couette geometry (cup=32 mm, bob=29.64 mm, cup length=44.25 mm), a Dynamic Temperature Ramp, Stress=60 Pa, Frequency=10 rad/sec, Temperature range=25-75° C., Rate=2° C./min, and time per measurement=10 seconds.

“Temperature-sensitive product” is any item whose structure and/or opacity changes with a change in temperature. A temperature-sensitive product comprises the resin solutions disclosed herein along with a carrier. Reference to a carrier herein means something in addition to the resin solution used to deliver or contain the resin solution for a particular application. For example, the resin solution may be packaged in a carrier that is one or more liquid-impermeable pouches or that is a plurality of shells that encapsulate the resin solutions thereby forming microcapsules, which are in turn incorporated into a solid final product. Or, the carrier may be another liquid such as an inert diluent or another polymer solution or a surfactant solution or an electrolyte solution, and the final product is in liquid form. For use in conjunction transportation vehicles or the human body or other products or things to disrupt or shield light emissions outside of the visible spectral range (e.g. infrared IR), resin solutions may be packaged to form as blankets, shields, and the like or to be draped on/near or mounted to/near a heat-generating item having IR signature that is to be disrupted or shielded.

“Product with passive opacification” is any item that can benefit from being opaque as a result of a temperature change during its use. Such a product incorporates an inventive passive opacification resin solution. In some embodiments, the solution may be contained against or near a surface of the product. In other embodiments, the solution may be mixed with a hydrophobic liquid. For example, resin solutions providing passive opacification may be contained as a layer between a surface of an underlying product and a clear material such as a pane of glass. Underlying products are products without limit that can accommodate and benefit from a resin solution that provides passive opacification.

“Transparent product” is a specific type of underlying product that has at least one portion that is transparent at ambient temperature and pressure. An inventive passive opacification resin solution may be incorporated with the transparent portion to form the transparent product. Transparent products include but are not limited to solar cells, building windows and sky lights, vehicle windows and roofs, greenhouses, optical lenses, optical sensors, and other products that are transparent at some times during use and can benefit from being opaque during other times of use.

“Transparent portion” is a part of the product that is transparent, that is, substantially see-through. Exemplary transparent portions include but are not limited to glass, plexi-glass, clear discrete polymer films, quartz or other transparent minerals, fluids—for example, hydrophobic fluids.

“Ambient pressure” means atmospheric pressure (1 atm) which may vary slightly ±5% or even 2.5%, or even 1%.

### Materials and Preparation

Resins comprising a hydrophobic group and a hydrophilic group may be selected from any of the following: an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof.

Basic resin synthesis includes: reaction one or more an electrophilic pre-polymers with a co-reactant having active hydrogen functionality. The pre-polymers generally contain functional groups such as epoxys and isocyanates. The co-reactants are typically polyfunctional amines, carboxylic and/or mineral acids (and acid anhydrides), and alcohols.

An exemplary epoxy functional resin/polymer suitable for use in the resin solutions of the present invention may be prepared by reacting in water: (A) an epoxy pre-polymer of (1) one or more aromatic polyols and (2) one or more epoxy functional materials with (B) a di- or polyamine that are hydrophilic in the optional presence of a catalyst and in the absence of a cross-linking agent. Upon dissolution of the resin in water and neutralization, an aqueous thermo-thickening resin solution is generally formed. Choice of the hydrophobic compound can be made according to the chemical functionality and/or performance desired.

Suitable epoxy-functional materials may contain at least one epoxy or oxirane group in the molecule, such as di- or polyglycidyl ethers of polyhydric alcohols. Preferably, the epoxy-functional material contains at least two epoxy groups per molecule. Suitable polyepoxide reactants include, without limitation, diglycidyl aromatic compounds such as the diglycidyl ethers of polyhydric phenols such as 2,2-bis(4-hydroxyphenyl)propane (bisphenol A), 2,2-bis(4-hydroxy-3-methylphenyl)propane, 4,4′-dihydroxybenzophenone, dihydroxyacetophenones, 1,1-bis(4hydroxyphenylene)ethane, bis(4-hydroxyphenyl)methane, 1,1-bis(4hydroxyphenyl)isobutane, 2,2-bis(4-hydroxy-tert-butylphenyl)propane, 1,4-bis(2-hydroxyethyl)piperazine, 2-methyl-1,1-bis(4-hydroxyphenyl)propane, bis-(2-hydroxynaphthyl)methane, 1,5-dihydroxy-3-naphthalene, and other dihydroxynaphthylenes, catechol, resorcinol, and the like. Also suitable are the diglycidyl ethers of aliphatic diols, including the diglycidyl ethers of 1,4-butanediol, cyclohexanedimethanols, ethylene glycol, propylene glycol, diethylene glycol, dipropylene glycol, triethylene glycol, tripropylene glycol, polypropylene glycol, polyethylene glycol, poly(tetrahydrofuran), 1,3-propanediol, 2,2,4-trimethyl-1,3-pentanediol, 1,6-hexanediol, 2,2-bis(4-hydroxycyclohexyl)propane, and the like. Diglycidyl esters of dicarboxylic acids can also be used as polyepoxides. Specific examples of compounds include the diglycidyl esters of oxalic acid, cyclohexanediacetic acids, cylcohexanedicarboxylic acids, succinic acid, glutaric acid, phthalic acid, terephthalic acid, isophthalic acid, naphthalene dicarboxylic acids, and the like. A polyglycidyl reactant may be used, preferably in a minor amount in combination with diepoxide reactant. Novolac epoxies may be used as a polyepoxide-functional reactant. The novolac epoxy resin may be selected from epoxy phenol novolac resins or epoxy cresol novolac resins. Other suitable higher-functionality polyepoxides are glycidyl ethers and esters of triols and higher polyols such as the triglycidyl ethers of trimethylolpropane, trimethylolethane, 2,6-bis(hydroxymethyl)-p-cresol, and glycerol; tricarboxylic acids or polycarboxylic acids. Also useful as polyepoxides are epoxidized alkenes such as cyclohexene oxides and epoxidized fatty acids and fatty acid derivatives such as epoxidized soybean oil. Other useful polyepoxides include, without limitation, polyepoxide polymers such as acrylic, polyester, polyether, and epoxy resins and polymers, and epoxy-modified polybutadiene, polyisoprene, acrylobutadiene nitrile copolymer, or other epoxy-modified rubber-based polymers that have a plurality of epoxide groups. A preferred epoxy functional material is diglycidyl ether of bisphenol A (Bis A).

Suitable aromatic polyols have an average functionality of at least two. The aromatic polyol may contain mono-functional, di-functional, tri-functional, and higher functional alcohols. The aromatic polyol may have one, two, three, or more aromatic rings. In one or more embodiments, diols are used, but when branching is desired, higher functionality aromatic alcohols are included. Exemplary aromatic polyols include polyhydric phenols such as 2,2-bis(4-hydroxyphenyl)propane (bisphenol A), 2,2-bis(4-hydroxy-3-methylphenyl)propane, 4,4′-dihydroxybenzophenone, dihydroxyacetophenones, 1,1-bis(4hydroxyphenylene)ethane, bis(4-hydroxyphenyl)methane, 1,1-bis(4hydroxyphenyl) isobutane, 2,2-bis(4-hydroxy-tert-butylphenyl)propane, 1,4-bis(2-hydroxyethyl)piperazine, 2-methyl-1,1-bis(4-hydroxyphenyl)propane, bis-(2-hydroxynaphthyl)methane, 1,5-dihydroxy-3-naphthalene, and other dihydroxynaphthylenes, catechol, resorcinol, and the like. A preferred aromatic polyol is bisphenol A.

Useful catalysts for forming the pre-polymer include any that activate an oxirane ring, such as tertiary amines or quaternary ammonium salts (e.g., benzyldimethylamine, dimethylaminocyclohexane, triethylamine, N-methylimidazole, tetramethyl ammonium bromide, and tetrabutyl ammonium hydroxide.), tin and/or phosphorous complex salts (e.g., (CH₃)₃ SNI, (CH₃)₄ PI, triphenylphosphine, ethyltriphenyl phosphonium iodide, tetrabutyl phosphonium iodide) and so on.

Exemplary di- and polyamines include, but are not limited to polyamines, including diamines such as ethylenediamine, diethylenetriamine, triethylenetetramine, dimethylaminopropylamine, dimethylaminobutylamine, diethylaminopropylamine, diethylaminobutylamine, dipropylamine, and piperizines such as 1-(2-aminoethyl)piperazine, polyalkylenepolyamines such as triethylenetetramine, tetraethylenepentamine, pentaethylenehexamine, tripropylenetetramine, tetrapropylenepentamine, pentapropylenehexamine, N,N′-bis(3-aminopropyl)ethylenediamine, N-(2-hydroxyethyl)propane-1,3-diamine, and polyoxyalkylene amines such as those available from BASF SE under the tradename BAXXODUR® or from Huntsman under the trademark JEFFAMINE® (polyether amine).

An exemplary epoxy pre-polymer comprises bisphenol A (Bis A) and the diglycidyl ether of bisphenol A (DGEBA) formed using a phosphine catalyst (e.g. triphenylphosphine), having an equivalent weight of about 490-530. The pre-polymer may be reduced to about 70-80% non-volatile (NV) content in an organic solvent for ease of handling. An exemplary polyamine is a polyether amine that is amine functional on both ends, for example, polyether amine. This polyether amine is heated to 90° C., and then the epoxy pre-polymer is added such that the amine/epoxy ratio is between 1.05 and 1.7, specifically in the range of approximately 1.3-1.4. The mixture is heated to 115-120° C. and reacted until it is just below the gel point. Organic solvents can be left in, or stripped out by vacuum distillation during the reaction.

Once the reaction has proceeded and the resin is just below the gel point, the resin solution is made by transferring the hot resin to a solution of water and an acid under agitation. The concentration of the acid is such that the neutralization of the resin with the acid is at least 40%, and the final solution is at least 5-10% NV. It is this resin solution that exhibits opacification and will generally exhibit thermo-thickening behavior as well. Opacification may occur, however, at temperatures that are too high to be useful for practical purposes. The addition of an ionic strength adjuster, for example a salt (e.g. >0.1% by weight calcium chloride) lowers the temperature where opacification occurs. Concentration of the ionic strength impacts the temperature where opacification occurs.

The non-volatile content is tailored to final uses. The aforementioned opacity changing properties of these resin solutions are unique in both their occurrence and magnitude.

At elevated temperatures the resin solution transitions from transparent at, for example at room temperature to nearly 100% opaque at elevated temperatures, for example >50° C. The temperature at which opacification occurs can be controlled by numerous formulation parameters such as resin concentration (i.e. % solids), resin molecular weight (Mₙ), resin composition (e.g. hydrophilic lipophilic balance), solution pH (i.e. % neutralization), ionic strength of the solution, and optionally additives to reduce the freezing point of the aqueous resin solution.

Sample Product Specifications are:

% NV Range: 5-50% by weight;

Density: 1.008-1.056 (g/ml)

Weight per gallon: 8.4-8.8;

Milliequivalents acid/g NV: 0.31-0.80;

Milliequivalents base/g NV: 0.64-0.80; and

Molecular weight (Mₙ): 7,500-150,000 Daltons.

Ionic strength adjuster content: 0.1 to 15 wt. %, or even 0.5-10 wt. %, or even 1-5 wt. %.

### Applications

Resin solutions having passive opacification and optional thermo-thickening properties may be suitable for many applications that are not related to the formation of coatings. Of interest are those applications that include exposure to temperature changes to take advantage of the opacity properties. Some examples include products that that are transparent at some times during use and can benefit from being opaque during other times of use.

One application is thermal management of solar cells and more specifically solar powered hot water heaters. In summer months or warm climates that experience high quantities of sunlight, it is possible that solar powered hot water heaters will overheat the water increasing the risk of scalding or burns. This temperature responsive passive opacification serves as a means to turn down or turn off a solar panel when temperatures rise too high. This would prevent generating superheated water and potential damage to the solar cell. Since these materials can be tuned to a specific temperature range, we can specify the temperature at which the resin transitions from transparent to opaque.

A second application is in sky lights for thermal management in homes or commercial buildings. The use of these materials contained within windows or skylights allow for passive thermal management and are a means to reduce dependence on air conditioning which increases energy efficiency. A similar application is in vehicle roofs or windows (not the windshield) as a passive means to keep vehicles cool when exposed to direct sunlight.

Another similar application is in greenhouses. Traditionally, the glass in greenhouses is painted or tinted white to keep the temperature down and lessen sunlight exposure. These resins could be used to selectively opacify greenhouse glass walls when temperatures rise. When temperatures are reduced, the greenhouse walls with return to their original transparency.

Another potential application is in privacy glass. This resin could be incorporated into windows or glass walls that contain a small heating element. When desired, the heating element could be turned on to initiate a change in the opacity of the wall and generate a private area when desired. These materials could be used for privacy glass in shower or steam room doors. Once heated by steam, the resin transitions to opaque to improve privacy. When not in use the doors will revert to their original transparent state.

Another application is in optical lenses and displays with tunable opacity. By incorporating a small heating unit into an enclosure, the transparency of the lens or display can be manipulated. This could be beneficial in virtual reality headgear such as the Microsoft HoloLens, Sony's Project Morpheus, Oculus Rift, or Google Glass. When the heating element is activated, the lens will opacify and scatter light. However, when not in use the lens will be transparent.

A further application is in conjunction with electronic devices having screens such as televisions, smart phones, tablets, and the like. A layer of resin solution may be incorporated adjacent to the screen of the device such that once the screen achieves a desired temperature after a pre-defined duration of use, the layer of resin solution goes opaque and the device needs to be turned off to cool down again before another use.

In addition, resin solutions may be used in conjunction with transportation vehicles or the human body or other products or things to disrupt or shield light emissions outside of the visible spectral range (e.g. infrared IR). That is, a layer of resin solution may be incorporated adjacent to an exterior surface of a heat-generating vehicle or product to disrupt or shield an IR signature of the vehicle or product.

Before describing several exemplary embodiments of the invention, it is to be understood that the invention is not limited to the details of construction or process steps set forth in the following description. The invention is capable of other embodiments and of being practiced in various ways.

### EMBODIMENTS

Various embodiments are listed below. It will be understood that the embodiments listed below may be combined with all aspects and other embodiments in accordance with the scope of the invention.

### Embodiment 1

An aqueous resin solution for non-coating applications comprising: a resin comprising a hydrophobic group and a hydrophilic group, the resin being selected from an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof; and water; optionally, a salting component; an ionic strength adjuster; the solution being substantially free of a cross-linking agent; wherein the solution exhibits a change in opacity in a temperature range from 0° C. to <100° C. at ambient pressure.

### Embodiment 2

The aqueous resin solution of embodiment 1, wherein the ionic strength adjuster comprises one or more compounds selected from the group consisting of: inorganic salts, ammonium salts, and metal organic salts.

### Embodiment 3

The aqueous resin solution of any of embodiments 1-2, wherein the resin is a reaction product of (A) an epoxy pre-polymer comprising an aromatic polyol and an epoxy functional material and (B) a di- or polyamine.

### Embodiment 4

The aqueous resin solution of embodiment 3, wherein the aromatic polyol comprises a diphenylmethane derivative.

### Embodiment 5

The aqueous resin solution of any of embodiments 3-4, wherein the epoxy functional material comprises a di- or polyglycidyl ether of a polyhydric alcohol.

### Embodiment 6

The aqueous resin solution of any of embodiments 3-5, wherein the di- or polyamine comprises a polyoxyalkylene amine.

### Embodiment 7

The aqueous resin solution of embodiment 3, wherein the aromatic polyol comprises bisphenol A (Bis A), the epoxy functional material comprises diglycidyl ether of bisphenol A (DGEBA), and the di- or polyamine comprises polyether amine.

### Embodiment 8

The aqueous resin solution of any of embodiments 1-7, wherein the salting component is present and is selected from the group consisting of organic acids, mineral acids, and nitrogen-containing compounds.

### Embodiment 9

An aqueous resin solution comprising by weight: an epoxy resin in the range of 0.5-60%; water in the range of 40-99.5%; organic volatiles in the range of 0-25%; and an ionic strength adjuster in the range of 0.1 to 10%.

### Embodiment 10

The aqueous resin solution of embodiment 9, wherein percent neutralization is in the range of 40-110%.

### Embodiment 11

The aqueous resin solution of either of embodiments 9 or 10 comprising a number average molecular weight in the range of 7,500 to 150,000 Daltons.

### Embodiment 12

The aqueous resin solution of any of embodiments 9-11, wherein the epoxy resin is a reaction product of (A) an epoxy pre-polymer comprising an aromatic polyol and an epoxy functional material and (B) a di- or polyamine and the ionic strength adjuster comprises calcium chloride.

### Embodiment 13

The aqueous resin solution of any of embodiments 1-12, wherein the ionic strength adjuster comprises one or more compounds selected from the group consisting of: calcium chloride, sodium chloride, ammonium sulfate, calcium stearate, and sodium acetate.

### Embodiment 14

A product with passive opacification comprising: an underlying product; and the aqueous resin solution of any one of embodiments 1-13 associated with the underlying product.

### Embodiment 15

The product of embodiment 14, wherein the underlying product is a transparent product comprising a transparent portion that is one or more of the following: glass, plexi-glass, a clear discrete polymer film, a transparent mineral, and a fluid.

### Embodiment 16

The product of either of embodiments 14 or 15 in the form of one or more of the following: solar cells, building windows, sky lights, vehicle windows, vehicle roofs, greenhouses, optical lenses, electronic devices with screens, and transportation vehicles.

### Embodiment 17

A method of making an aqueous resin solution for non-coating applications, the method comprising: forming a resin comprising a hydrophobic group and a hydrophilic group, the resin being selected from an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof; and dissolving the resin in water, and optionally, a salting component, in the substantial absence of a cross-linking agent;

adding an ionic strength adjuster; thereby forming the aqueous resin solution that exhibits a change in opacity over a temperature range from 0° C. to <100° C. at ambient pressure.

### Embodiment 18

The method of embodiment 17, wherein the resin is a reaction product of (A) an epoxy pre-polymer comprising an aromatic polyol and an epoxy functional material and (B) a di- or polyamine.

### Embodiment 19

The method of embodiment 18, wherein the aromatic polyol comprises bisphenol A (Bis A), the epoxy functional material comprises diglycidyl ether of bisphenol A (DGEBA), and the di- or polyamine comprises polyether amine.

### Embodiment 20

A method of providing a product with passive opacification, the method comprising: obtaining the aqueous resin solution of any one of embodiments 1-13; associating the aqueous resin solution with an underlying product; and forming the product with passive opacification whose opacity changes over a temperature range from 0° C. to <100° C. at ambient pressure.

### Embodiment 21

Use of an aqueous resin solution in non-coating applications to provide a change in opacity over a temperature range of about 0° C. to <100° C. at ambient pressure.

### EXAMPLES

The following examples were prepared and tested at ambient pressures.

### Example 1

An epoxy precursor polymer was made as follows. 908.6 grams of diglycidyl ether of bisphenol A (Bis A) and 285 grams of Bis A were mixed in a reaction vessel under a nitrogen (N₂) blanket, heated to 125° C., and 0.5 grams of catalyst triphenylphosphine were added to the reaction vessel. The reaction exothermed to 190-200° C. The material was cooled to 177° C. and held at that temperature for 1 hour. The equivalent weight of the pre-polymer was 475-540. The material was cooled to 150° C. and, 100 grams of isobutanol and 308 grams of toluene were added slowly.

### Example 2

### Comparative

In accordance with Example 2 of co-owned U.S. Ser. No. 62/050,290, 679.1 grams of polyether amine was added to a reaction vessel under a nitrogen (N₂) blanket, heated to 90° C., and 321 grams of the pre-polymer of Example 1 were added. The mixture was heated to 115-120° C., vacuum stripped and solvent was collected, holding at 120° C. for 3-4 hours. The mixture was kept below the gel point, which was an equivalents ratio of approximately 1.36:1 amine:epoxy. The resulting resin was transferred to an acetic acid and water solution to form the resin solution. No cross-linking agents were present.

This solution was adjusted to a concentration of 30% non-volatiles (NV) and 70% total neutralization (TN).

Polymers of the resin solutions according to Example 2 are cationic, which means the polymers are positively charged when dispersed or dissolved in an aqueous solution.

### Example 3

Upon formation of the resin solution of Example 2, an alkaline earth metal salt (CaCl₂) was added resulting in a final concentration of 1 wt %.

### Example 4

### Testing

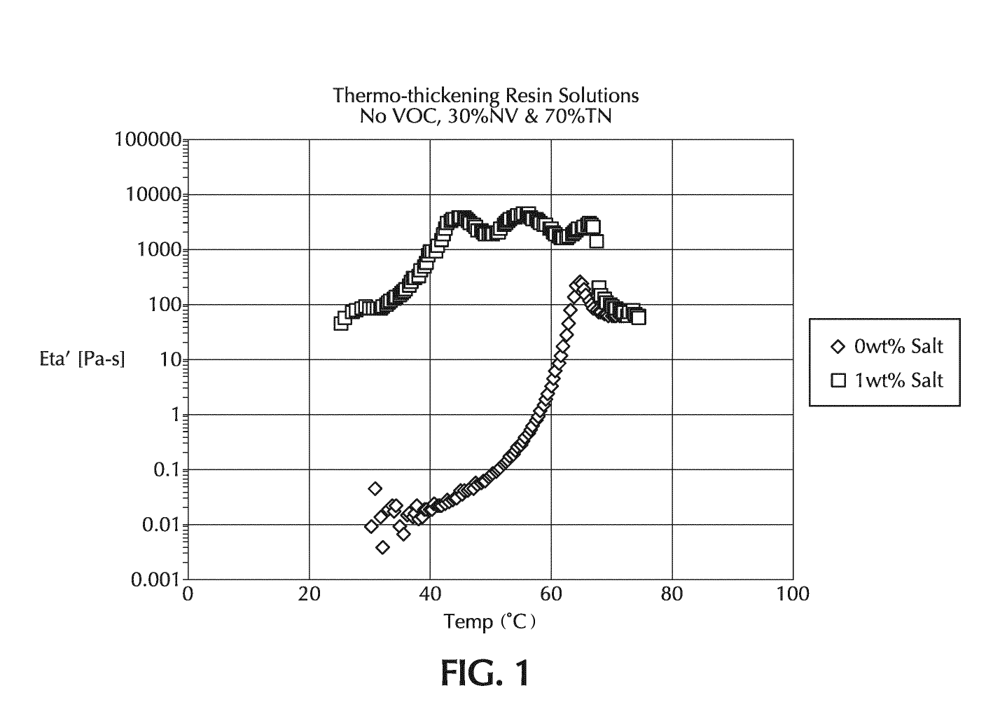

FIG. 1 shows the viscosity versus temperature log-plots for the resin solutions of Comparative Example 2 and Example 3, which demonstrates the difference in viscosity properties at two different ionic strengths. The resin solution of Example 2 shows multiple maximum viscosities over a fairly small temperature range of 40 to 70° C.

Various freezing point tests were conducted. Samples were tested at −21° C. for two hours to determine the effect on the resin solution. The resin solution of Example 3 was frozen after the test. At a temperature of −1° C., the resin solution was not yet frozen. The resin solution of Example 3 modified with 10, 20, or 30% (w/w) methanol did not freeze.

### Example 5

A transparent product was formed from two glass panels measuring 6 inches by 4 inches and the resin solution of Example 3. Rubber gasket material having a thickness of 1/16″ was cut to form a 0.5 inch border and was adhered to both glass panels with a silicone adhesive, leaving areas to allow insertion of syringe needles for injecting resin solution and for venting. A chilled resin solution of Example 3, with a lower viscosity than at room temperature, was injected between the glass panels. After injecting the resin solution, a final seal of silicone was applied to all sides between the glass panels.

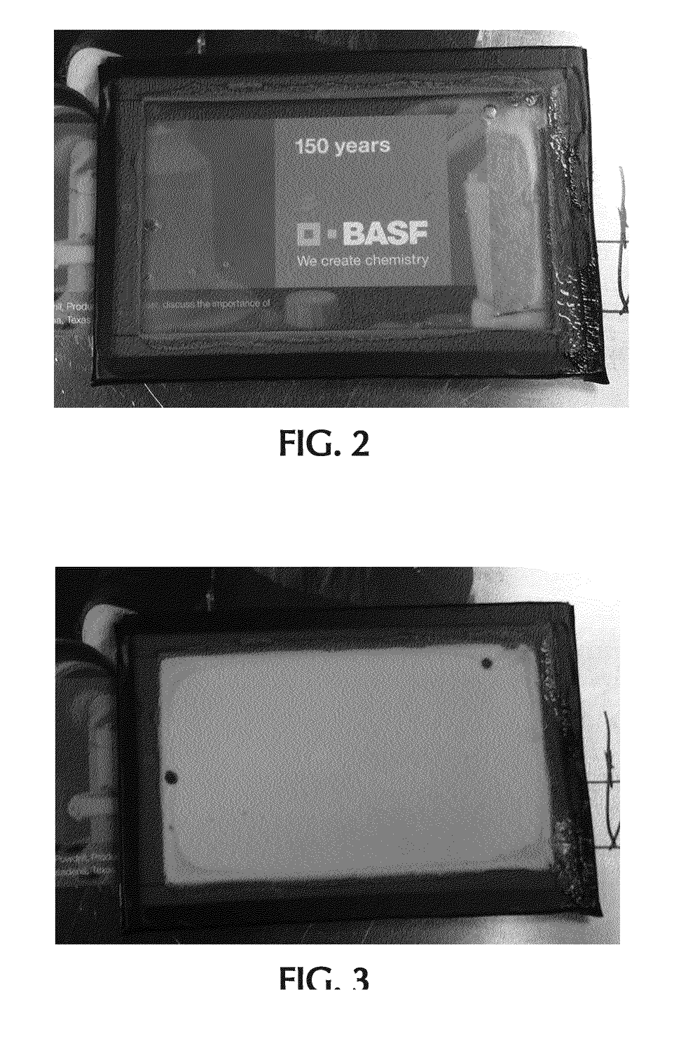

At 21° C., the resin solution was transparent as shown in FIG. 2. At elevated temperatures of >50° C., the resin solution was nearly 100% opaque as shown in FIG. 3. Upon cooling, the resin solution returned to being clear/transparent.

### Example 6

Several resin solutions in accordance with Comparative Example 2 or Example 3, without and with calcium chloride at varying non-volatiles (NV), total neutralization (TN), and CaCl₂ contents were prepared and analyzed. Table 1 provides a summary of the contents of the resin solutions.

TABLE 1

| Sample ID | % NV | % TN | % CaCl₂ |
|---|---|---|---|
| A | 10 | 90 | 0 |
| B | 10 | 90 | 0.1 |
| C | 10 | 90 | 1.0 |
| D | 30 | 50 | 0 |
| E | 30 | 50 | 0.1 |
| F⁽¹⁾ | 30 | 50 | 1.0 |
| G | 30 | 70 | 0 |
| H | 30 | 70 | 0.1 |
| I | 30 | 70 | 1.0 |
| J | 30 | 90 | 0 |
| K | 30 | 90 | 0.1 |
| L | 30 | 90 | 1.0 |
| M | 50 | 90 | 0 |
| N | 50 | 90 | 0.1 |
| O | 50 | 90 | 1.0 |
| P | 30 | 70 | 0.5 |
| Q | 30 | 70 | 0.75 |
| R | 30 | 70 | 1.5 |

⁽¹⁾Sample “F” was opaque at room temperature, transparent at 30° F.
All other samples, A-E and G-O were transparent at room temperature (~21° C.).

At room temperature (˜21° C.), the 1.0% CaCl₂ samples exhibited a higher viscosity than 0 and 0.1% salt solutions.

To examine the impact of temperature on light transmission and change in opacity, samples were run in a temperature controlled UV-Vis spectrometer. The change in transparency of the system was measured with 750 nm light. Measurements were made at 25, 30, 32, 34, 36, 38, 40, 42, 44, 46, 48, 50, and 55° C. Data were collected as absorption (A). From the absorption values, percent transmission (% T) was calculated via the following formula:

% T=10^{-A}

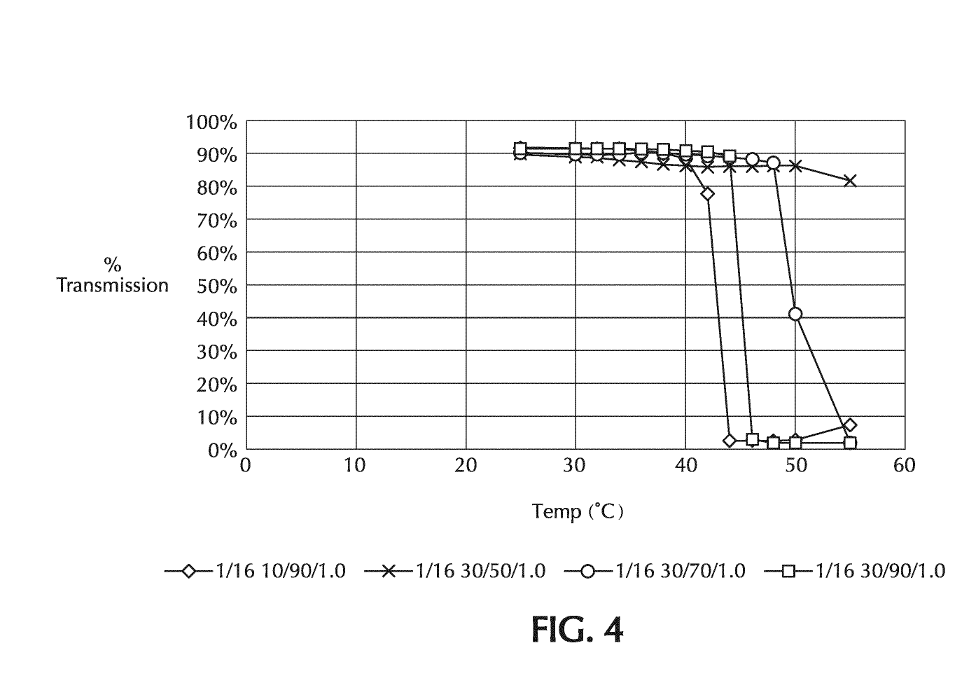

Only samples containing 1.0% CaCl₂ exhibited change in opacity in this temperature range (25-55° C.). FIG. 4 shows percent transmission versus temperature for Samples C, F, I, and L for sample thicknesses of 1/16″. While it was hypothesized that percent neutralization would impact the change in opacity, the results of FIG. 4 were unexpected. Samples with 50% neutralization (i.e., Example F: 30% NV, 50% TN, 1.0% CaCl₂), appeared opaque at room temperature but did not exhibit a strong change in percent transmission (% T) with elevated temperatures, as shown graphically. As % TN increased, the opacity transition temperature dropped. A reduction in % NV reduced the opacity transition temperature as well.

Effect of Sample Thickness on Sample I (30% NV/70% TN/1.0% CaCl₂).

Sample thickness impacted the amount of light able to pass through the sample after a change in opacity occurred, as shown in Table 2. At room temperature all thicknesses had similar percent transmission near 90. However, at 55° C., the percent transmission of light dropped to 3.71±1.08, 1.87±0.03, and 1.09±0.01 for 1/32, 1/16, and ⅛ of an inch samples, respectively. These data are the average ±standard deviation of three replicates.

TABLE 2

| Thickness | % T at | % T at | % T at | % T at |
|---|---|---|---|---|
| (inches) | 25° C. | 46° C. | 50° C. | 55° C. |
| 1/32 | 91.8 ± 0.2 | 4.05 ± 1.14 | 4.07 ± 1.47 | 3.71 ± 1.08 |
| 1/16 | 90.7 ± 0.2 | 2.02 ± 0.03 | 1.95 ± 0.03 | 1.87 ± 0.03 |
| ⅛ | 89.5 ± 0.2 | 1.26 ± 0.02 | 1.17 ± 0.02 | 1.09 ± 0.01 |

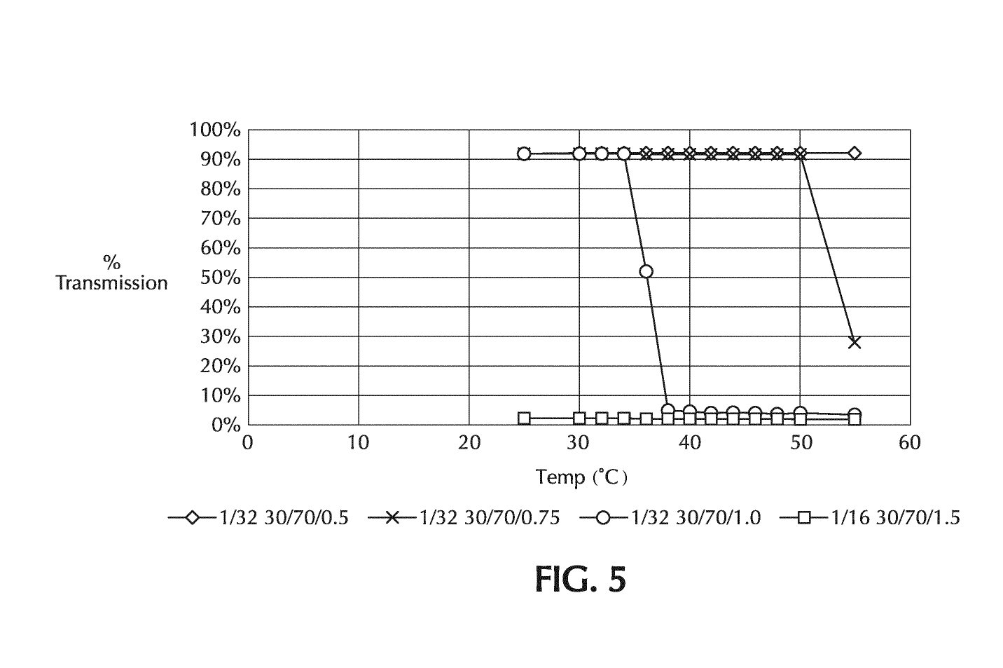

Effect of salt concentration. Resin solutions with salt concentrations between 0.5 and 1.5 wt. % were prepared (samples P, Q, I, and R). Adjustments in the amount of CaCl₂ impacted the opacity transition temperature as shown in FIG. 5. Sample R at 1.5 wt. % CaCl₂ started opaque and generally did not change transmission over 25-55° C. Sample P at 0.5 wt. % CaCl₂ started with a higher % transmission than Sample R but generally did not change transmission over 25-55° C. Sample I at 1.0 wt. % CaCl₂ showed an opacity transition temperature at ˜35° C. Sample Q at 0.75 wt. % CaCl₂ showed an opacity transition temperature at ˜50° C.

### Example 7

### Testing

Light Box Demonstration.

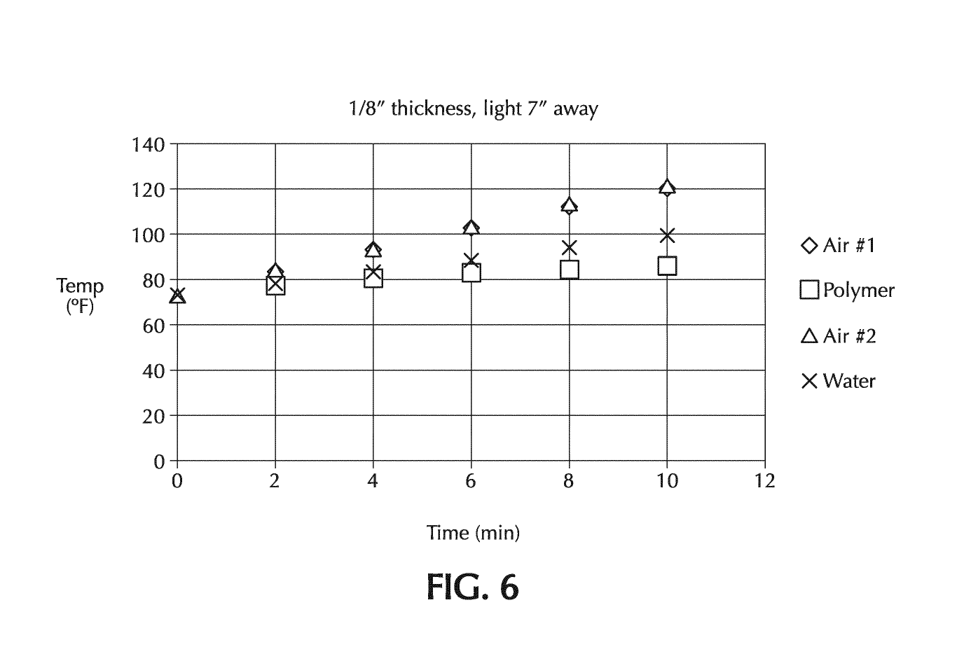

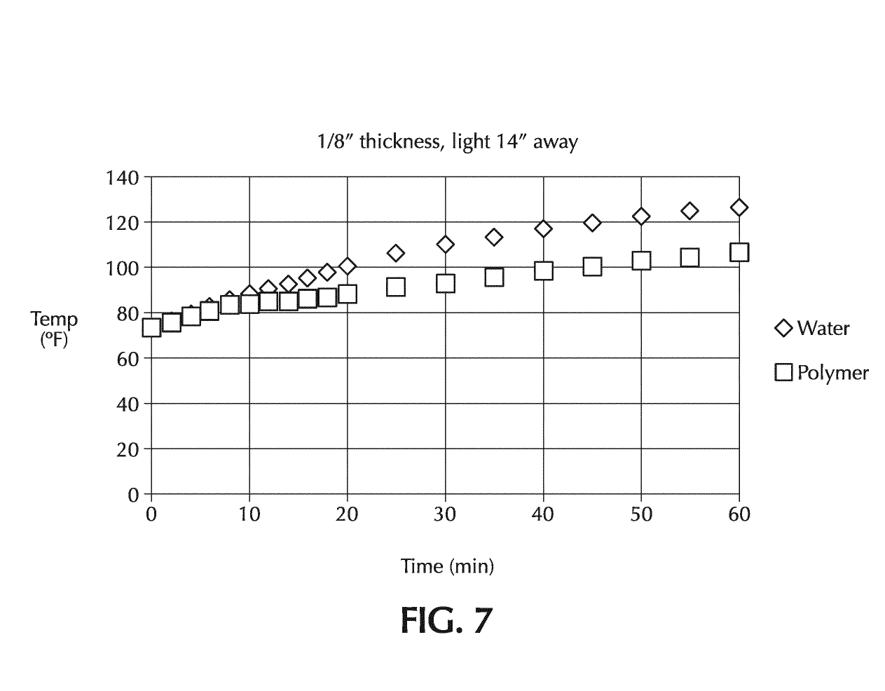

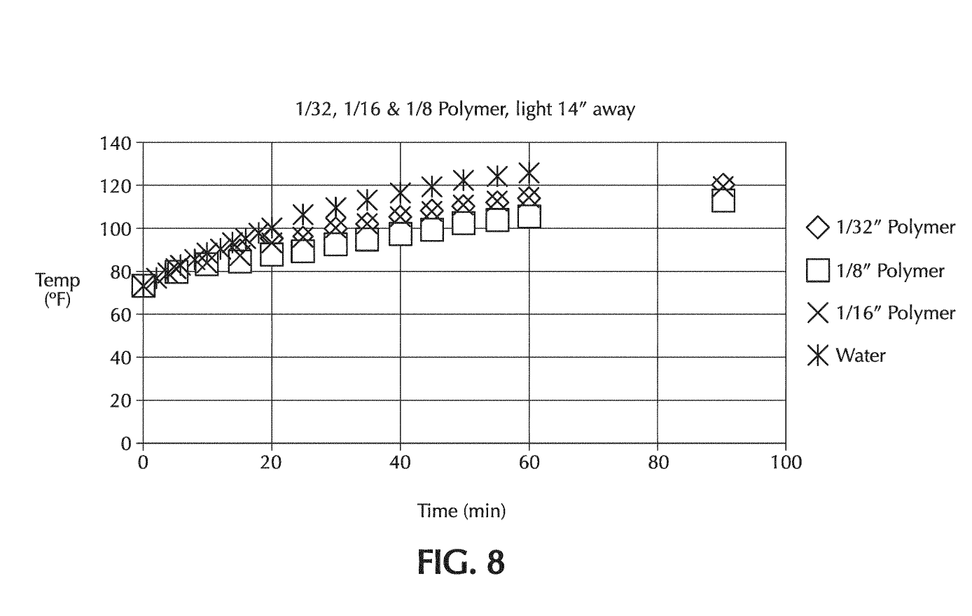

To test the impact of the change in opacity on thermal management, a test cell was constructed. A demo box was built from insulating foam to accommodate a 12×12″ pane of glass on its top surface. A halogen light bulb was suspended above the demo box. Thermocouples inside the test cell were used to measure the internal temperature of the demo box. Mock windows used in the test cell were created from two panes of glass separated with silicon spacers 1/32″, 1/16^{th}, and ⅛″ thick. The void space was filled with air, water, or a polymer resin according to Example I (30% NV, 70% TN, 1.0% CaCl₂). Initial tests with the thickest panels (⅛″) are shown in FIG. 6. The polymer resin solution reduced the internal temperature in the test cell as compared to both water and air filled mock windows. These data were confirmed at a different light distance as shown in FIG. 7. The impact of thickness of the polymer resin solution on the percent transmission was determined in Table 2, but its impact on keeping the test cell cool is shown in FIG. 8. The thickest sample provided the best temperature reduction compared to a water-filled window. The 1/32″ and 1/16″ windows exhibited very similar temperature profiles.

### Example 8

The resin solution of Example 2 was adjusted to a concentration of 30% non-volatiles (NV) and 53.8% total neutralization (TN), and upon its formation, an alkaline earth metal salt (CaCl₂) was added resulting in a final concentration of 3 wt %. The resulting resin solution was clear at 0° C. and opaque at room temperature (˜21° C.).

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

1. An aqueous resin solution for non-coating application comprising:
a resin comprising a hydrophobic group and a hydrophilic group, the resin being selected from the group consisting of an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof;
water; and
an ionic strength adjuster;
wherein the solution is substantially free of a cross-linking agent and exhibits a change in opacity in a temperature range from 0° C. to <100° C. at ambient pressure.

2. The aqueous resin solution of claim 1, wherein the ionic strength adjuster comprises one or more compounds selected from the group consisting of inorganic salts, ammonium salts, and metal organic salts.

3. The aqueous resin solution of claim 2, wherein the ionic strength adjuster comprises one or more compounds selected from the group consisting of calcium chloride, sodium chloride, ammonium sulfate, calcium stearate, and sodium acetate.

4. The aqueous resin solution of claim 1, wherein the resin is a reaction product of (A) an epoxy pre-polymer comprising an aromatic polyol and an epoxy functional material and (B) one of a diamine and a polyamine.

5. The aqueous resin solution of claim 4, wherein the aromatic polyol comprises a diphenylmethane derivative.

6. The aqueous resin solution of claim 4, wherein the epoxy functional material comprises one of a diglycidyl and a polyglycidyl ether of a polyhydric alcohol.

7. The aqueous resin solution of claim 4, wherein the one of the diamine and the polyamine comprises a polyoxyalkylene amine.

8. The aqueous resin solution of claim 4, wherein the aromatic polyol comprises bisphenol A (Bis A), the epoxy functional material comprises diglycidyl ether of bisphenol A (DGEBA), and the one of the diamine and the polyamine comprises polyether amine.

9. The aqueous resin solution of claim 1, wherein the aqueous resin solution further comprises a salting component selected from the group consisting of organic acids, mineral acids, and nitrogen-containing compounds.

10. An aqueous resin solution comprising by weight:
an epoxy resin in the range of 0.5-60%;
water in the range of 40-99.5%;
organic volatiles in the range of 0-25%; and
an ionic strength adjuster in the range of 0.1 to 10%.

11. The aqueous resin solution of claim 10, wherein the ionic strength adjuster comprises one or more inorganic salts, ammonium salts, and metal organic salts selected from the group consisting of calcium chloride, sodium chloride, ammonium sulfate, calcium stearate, and sodium acetate.

12. The aqueous resin solution of claim 10, wherein percent neutralization is in the range of 40-110%.

13. The aqueous resin solution of claim 10 comprising a number average molecular weight in the range of 7,500 to 150,000 Daltons.

14. The aqueous resin solution of claim 10, wherein the epoxy resin is a reaction product of (A) an epoxy pre-polymer comprising an aromatic polyol and an epoxy functional material and (B) on of a diamine and a polyamine, and the ionic strength adjuster comprises calcium chloride.

15. A product with passive opacification comprising:
an underlying product; and
the aqueous resin solution of claim 1 associated with the underlying product.

16. The product of claim 15, wherein the underlying product is a transparent product comprising a transparent portion that is one or more of glass, plexi-glass, a clear discrete polymer film, a transparent mineral, and a fluid.

17. The product of claim 15, wherein the product is one or more of solar cells, building windows, sky lights, vehicle windows, vehicle roofs, greenhouses, optical lenses, electronic devices with screens, and transportation vehicles.

18. A method of making an aqueous resin solution for non-coating applications, the method comprising:
(A) forming a resin comprising a hydrophobic group and a hydrophilic group, the resin being selected from the group consisting of an epoxy resin, a phenol-formaldehyde resin, a polyurethane resin, an acrylic resin, a polyester resin, an acrylic-urethane resin, a melamine resin, a melamine-formaldehyde resin, an amino resin, and combinations thereof;
(B) dissolving the resin in water that is substantially absent of a cross-linking agent; and
(C) adding an ionic strength adjuster;
wherein the aqueous resin solution exhibits a change in opacity over a temperature range from 0° C. to <100° C. at ambient pressure.

19. The method of claim 18, wherein the resin is a reaction product of (A) an epoxy pre-polymer comprising an aromatic polyol and an epoxy functional material and (B) one of a diamine and a polyamine.

20. The method of claim 19, wherein the aromatic polyol comprises bisphenol A (Bis A), the epoxy functional material comprises diglycidyl ether of bisphenol A (DGEBA), and the at least one of the diamine and the polyamine comprises polyether amine.

21. A method of providing a product with passive opacification, the method comprising:
obtaining the aqueous resin solution of claim 1;
associating the aqueous resin solution with an underlying product; and
forming the product with passive opacification, wherein an opacity of the formed product changes over a temperature range from 0° C. to <100° C. at ambient pressure.

22. (canceled)
